(19) United States
(12) Patent Application Publication
(10) Pub. No.: US 2022/0270143 A1
(43) Pub. Date: Aug. 25, 2022

(54) PLATFORM FOR ESTABLISHING CONNECTIONS FOR ON-LINE ADVERTISING

(71) Applicant: Yeiser Research & Development LLC, Santee, CA (US)

(72) Inventor: John O. Yeiser, IV, Santee, CA (US)

(21) Appl. No.: 17/680,218

(22) Filed: Feb. 24, 2022

Related U.S. Application Data
(60) Provisional application No. 63/153,048, filed on Feb. 24, 2021.

(51) Int. Cl. G06Q 30/02

(52) U.S. Cl. CPC G06Q 30/0277; G06Q 30/0273

(57) ABSTRACT

A platform and method for streaming live advertising provides user access to streaming content and coordinates collaboration between a host, who directs a sales presentation, a presenter, provides the sales presentation of a product under direction by the host, and a supplier of the product. The platforms provides a link between the different entities to select from, negotiate, and establish a collaboration with other entities for generating streaming content for advertising a supplier's product, then schedules a time slot for a streaming event and distributes the streaming content to consumer devices for display to prospective consumers.

### RELATED APPLICATIONS

This application claims the benefit of the priority of provisional application No. 63/153,048, filed Feb. 24, 2021, which is incorporated herein by reference in its entirety.

### FIELD OF THE INVENTION

The present invention relates to a method and system for providing a platform for connecting entities for producing on-line content for advertising and selling products or services to potential purchaser.

### BACKGROUND

The Internet has greatly expanded the reach of businesses seeking to sell products and services. As a result, many companies are abandoning or greatly reducing traditional advertising approaches in favor of new digital advertising platforms.

Web and mobile advertising also referred to as “online” advertising harnesses the power of Internet to deliver marketing messages to customers. The current form of online advertising allows user to interact with advertisements that are made beforehand and/or in near real time to promote product and services which is a one-way communication.

Television news, sporting events, concerts, celebrity interviews, live cooking competitions, have long known the value of live coverage of events. Brands and marketers are have recognized that live streaming content resonates more than on-demand content or recorded content, generating excitement, particularly among demographics that are responsive to popular that are is most likely to purchase products across different age groups and categories. Live advertising removes geographic restrictions and creates relationship that might not have previously been established, potentially worldwide.

Reaching out to those customers, connecting with them via live advertisements, can reinforce the bonds they already have with a brand. Including them in a “special event” helps deliver the message that a brand is determined to stay in touch, to include a consumer in its “inner circle”. When a brand streams live content, it creates a unique experience, a one-time moment in time that becomes another form of “appointment television.” Live advertisement has the capability of reaching thousands of potential customers around the world. But gaining real-world benefits requires the ability to convert online prospects into online customers. The more quickly you can get a potential customer to interact with an advertiser, the greater the likelihood that the potential customer becomes a customer. Prior solutions only provide a link to the website or mobile app or perhaps a feature synopsis, phone number or e-mail address in the ad or require the potential customer to go to the advertiser's website for more detailed information which makes the customer to abandon the advertisement.

Major players in the e-commerce industry have introduced digital programming that includes product demonstrations and endorsements. For example, Amazon Live features cooking shows, make-up demonstrations, work-out programs, and more with different personalities. The Amazon Influencer program allows participants to establish a presence on Amazon that can be customized and curated with products they recommend in videos on YouTube or pictures on Instagram. The participant is assigned their own URL, allowing them to promote their Amazon presence verbally to their followers. The influencer is compensated for purchases in a similar fashion as you would with the Amazon Associates program. TalkShopLive, Lash.Live, and UScreen offer different platforms for individuals and companies to advertise products and services they wish to sell.

The identified approaches typically focus on a single individual. While a few individuals may possess all of the skills, product knowledge, appearance and charisma to engage and retain potential audiences, livestreaming and television sales presentations such as HSN and QVC, it is much more common that multiple individuals will be required to make an effective presentation. For television, this requires coordination and scheduling to allow all participants to be present in a studio at the same time, as well as arrangements for a production crew.

### SUMMARY OF THE INVENTION

According to embodiments of the invention, an online social platform, referred to herein as “Otho” provides means for connecting a supplier, a host, and a presenter together to coordinate the advertising and sale of a product or service. The inventive platform brings three or more entities together and to generate content for viewing by prospective customers.

The inventive platform differs from existing approaches by proving a social platform that allow a host, a presenter, and a supplier to come together and provide an online shopping experience utilizing live and recorded video from multiple locations for sale to the consumer.

In one aspect of the invention, a platform for streaming live advertising to prospective consumers includes a platform administrator comprising one or more administration servers in communication with a network for providing user access to streaming content and for coordinating collaboration between entities, wherein the entities comprise a host, a presenter, and a supplier, wherein the host is one or more first entity who directs a sales presentation, the presenter is one or more second entity who provides the sales presentation of a product under direction by the host; wherein the one or more administration servers are configured to accept subscriptions from the entities and provide communication links between the entities to allow one entity to select from, negotiate, and establish a collaboration with other entities for generating streaming content advertising a supplier's product; and wherein the platform administrator is further configured to receive requests for scheduling a time slot for a streaming event associate with an established collaboration between entities and to distribute the streaming content to consumer devices for display to the prospective consumers. The platform administration may be further configured to facilitate transactions initiated by consumers for purchase of the supplier's product. The platform administration may be configured to determine compensation to one or more of the entities based on sales of the supplier's product and a negotiated compensation arrangement between collaborating entities. In some embodiments, the host and the presenter generate streaming content at a common location and in other embodiments, the host and the presenter generate streaming content at remote locations. The host may be a celebrity or influencer. The platform administration may be configured to receive inquiries or comments from the prospective consumers during live streaming of the streaming content and to provide the inquiries or comments to the host for directing the sales presentation. The platform administration may also be configured to collect reviews or ratings of one or more entity from other entities and to generate entity profiles to facilitate selection of an entity for a specific sales presentation. In some embodiments the streaming content is live video, while in other embodiments it may be audio only. The one or more of the entities appears in the streaming content as an avatar.

In another aspect of the invention, a method for streaming live advertising to prospective consumers includes providing a platform within a network for providing user access to streaming content and for coordinating collaboration between entities, wherein the entities comprise a host, a presenter, and a supplier, wherein the host is one or more first entity who directs a sales presentation, the presenter is one or more second entity who provides the sales presentation of a product under direction by the host; providing communication links between the entities to allow one entity to select from, negotiate, and establish a collaboration with other entities for generating streaming content advertising a supplier's product; and receiving requests for scheduling a time slot for a streaming event associate with an established collaboration between entities and to distribute the streaming content to consumer devices for display to the prospective consumers. The method may facilitate transactions initiated by consumers for purchase of the supplier's product and may involve determining compensation to one or more of the entities based on sales of the supplier's product and a negotiated compensation arrangement between collaborating entities. The host and the presenter may generate streaming content at a common location or at remote locations. The method may further include receiving inquiries or comments from the prospective consumers during live streaming of the streaming content and providing the inquiries or comments to the host for directing the sales presentation. Reviews or ratings of one or more entity from other entities may be collected to generate entity profiles to facilitate selection of an entity for a specific sales presentation. The streaming content may be one of live video and live audio. One or more of the entities appears in the streaming content as an avatar.

### BRIEF DESCRIPTION OF THE DRAWINGS

FIG. 1 is a high-level block diagram of a computing environment according to one embodiment.

FIG. 2 depicts an example block diagram of the components of environment that generates and controls live advertisements.

FIG. 3 illustrates a simulated home page for the inventive platform showing exemplary frames of a video of a presenter with an inset of the host.

FIG. 4A is a diagrammatic screen shot of a webpage for selecting a user's area of interest in a marketing presentation; FIG. 4B is a screen shot of the corresponding webpage on a simulated website.

FIGS. 5A-5D are flowcharts illustrating the steps of different aspects of the inventive platform where FIG. 5A shows the steps for signing up a new user and selecting their desired participation; FIG. 5B shows the steps by which a current user selects their desired participation; FIG. 5C shows the steps for a user (host, presenter or supplier) to participate in a live streaming activity; and FIG. 5D provides the steps by which a viewer/consumer can view and/or purchase items offered on platform programming.

FIG. 6 displays images of different programming options available for selection by prospective consumers. In this example, programming selections are categorized as the newest programming (upper panel) and trending programming (lower channel).

FIG. 7 displays images of talent options from which a supplier may select individuals who would be suitable for hosting and/or presenting the supplier's products or services.

FIG. 8 displays sample images of different product options from which a prospective customer can select. In this example, product options are categorized according to newest offerings (upper panel) and trending products (lower panel).

FIG. 9 displays a sample image with a chat/comment box allowing viewers to comment on the product or programming and interact with or provide feedback for the presenter and/or host.

FIGS. 10A-10C provide examples of information at the host, presenter, and supplier, respectively, would enter as part of the sign-up process; FIG. 10D illustrates an example display of the account page of a platform user indicating activity status and preparation for a live streaming activity; FIG. 10E provides an example display of consumer account information and preferences; FIG. 10F provides an example display of a profile page for a platform participant.

FIGS. 11A-11D provide examples of detailed questionnaires for creating accounts/subscribing for a host, presenter, supplier, and consumer, respectively.

### DETAILED DESCRIPTION OF EMBODIMENTS

### Definitions

The following definitions are used throughout the written description

“Host” means an influencer (social media) or someone who wants to direct the sales presentation. The Host draws viewers in and guides the presenter to maximize sales. The Host engages and provides questions for the Presenter regarding the product or service. The Host may also engage, in real time, with the participating viewers commenting in the chat/comment box. The functions of a Host may be performed by more than one individual. In one example, a host assistant may be working behind the scenes to, for example, participate in chats during the programming and monitor viewer response, including data, and feed viewer comments or data to the host and/or presenter. “Host” may also include the role of a director who coordinates or controls the programming production, i.e., someone who monitors response metrics and receives other feedback to assist in directing or guiding activity of the Presenter and Host.

“Presenter” means an individual who will focus on presenting the unique features of the product or service. The Presenter can physically have the product or a picture or virtual image of the product or the service. The Presenter will typically be an expert on demonstrating products or services.

“Supplier” means an individual or business entity, e.g., manufacturer, distributor, retailer, etc., who provides a product or service for the presenter to pitch and demonstrate during the presentation.

“Avatar” means one or more of a still image, an animation, an icon, or other non-human figure representing a person, as distinguished from a live person on video, or a unique voiceover representing a person. Any one or more of the host, presenter and/or supplier can be an “Avatar”.

The inventive platform and method for streaming live advertising provides user access to streaming content and coordinates collaboration between a host, who directs a sales presentation, a presenter, provides the sales presentation of a product under direction by the host, and a supplier of the product. The platforms provides a link between the different entities to allow them to select from, negotiate, and establish a collaboration with other entities for generating streaming content for advertising a supplier's product, then schedules a time slot for a streaming event and distributes the streaming content to consumer devices for display to prospective consumers.

The following provides a brief overview of an embodiment of an exemplary computing environment for implementing the inventive advertising scheme.

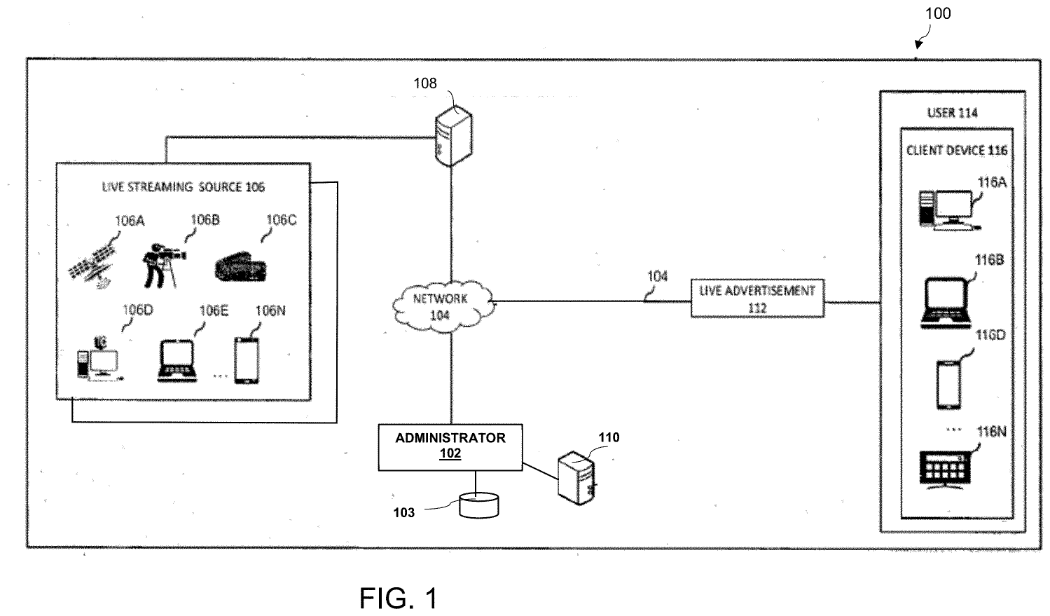

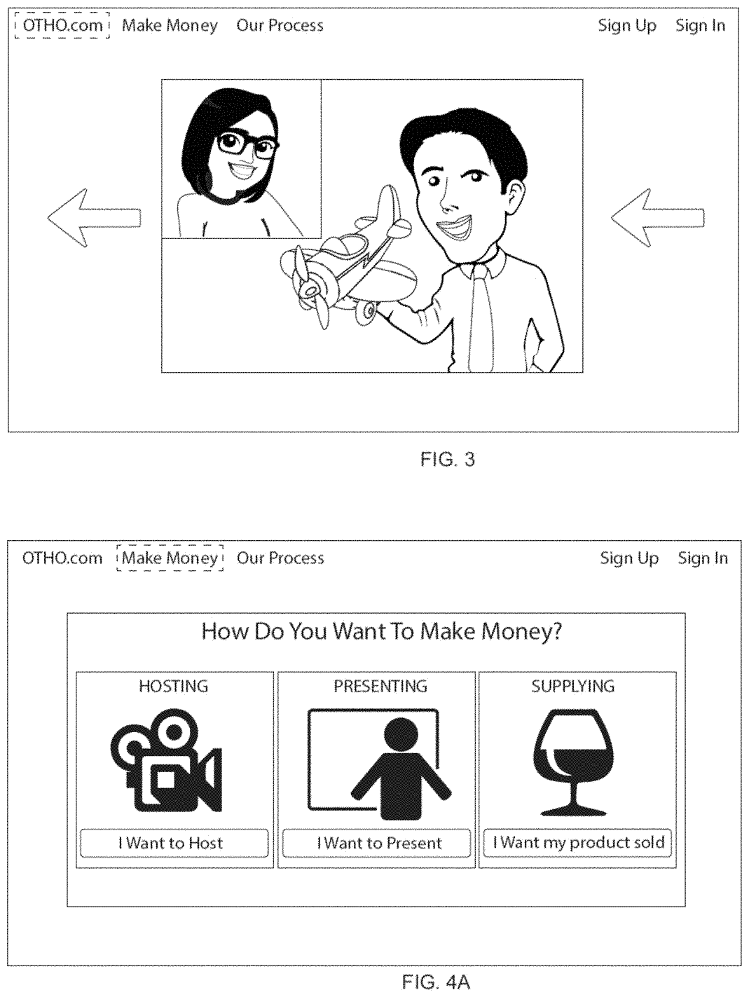

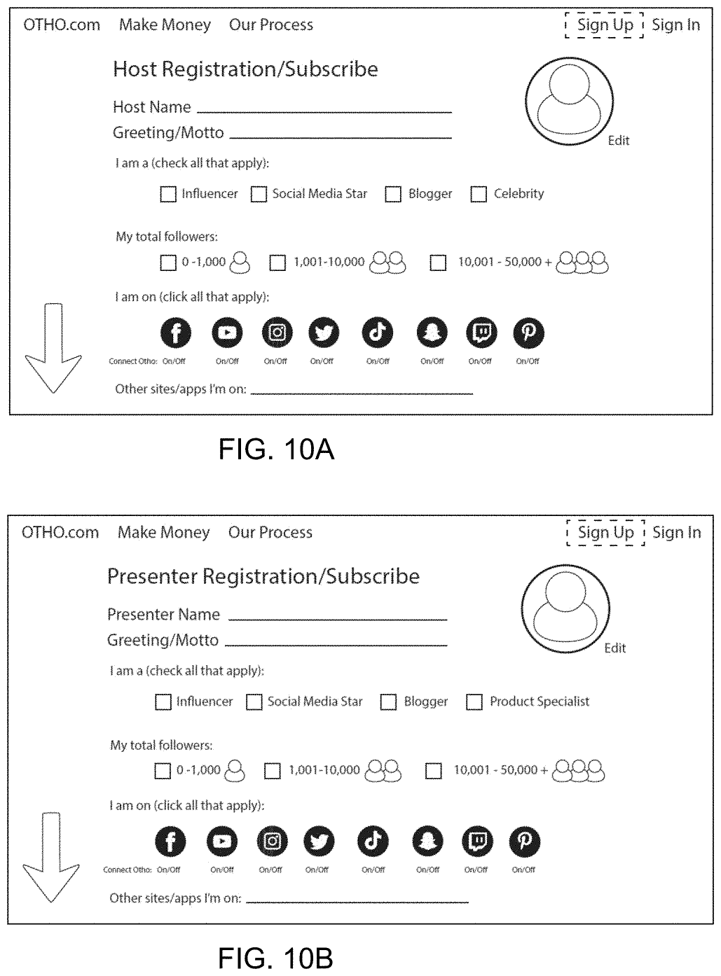

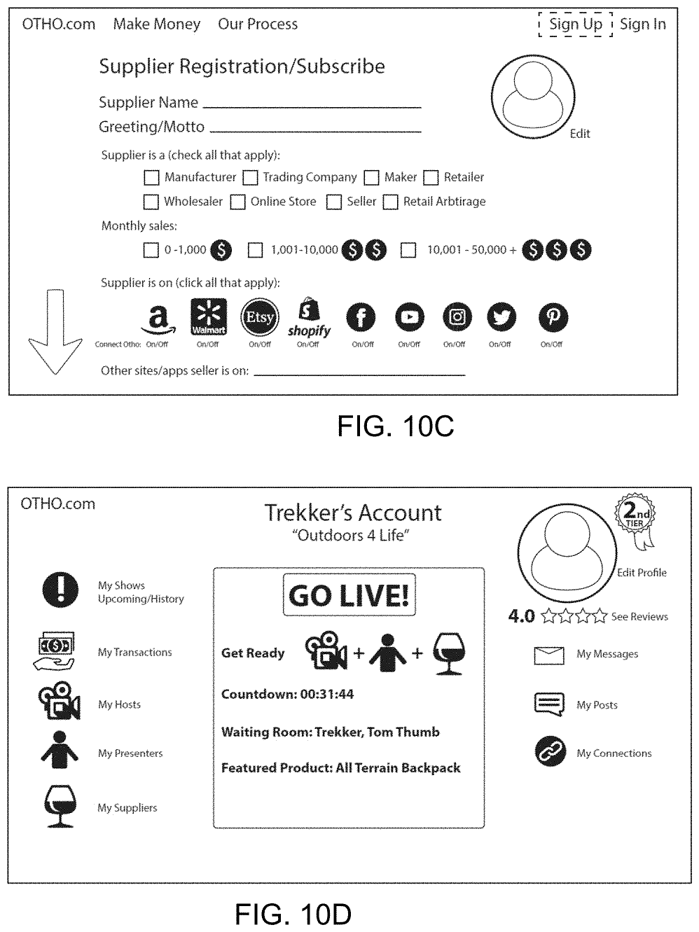

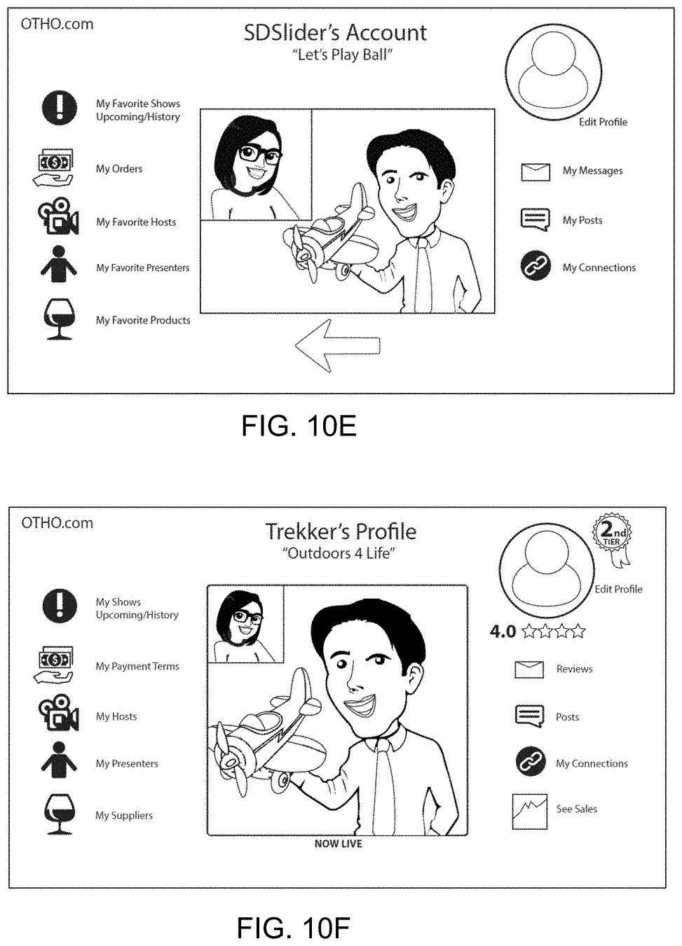

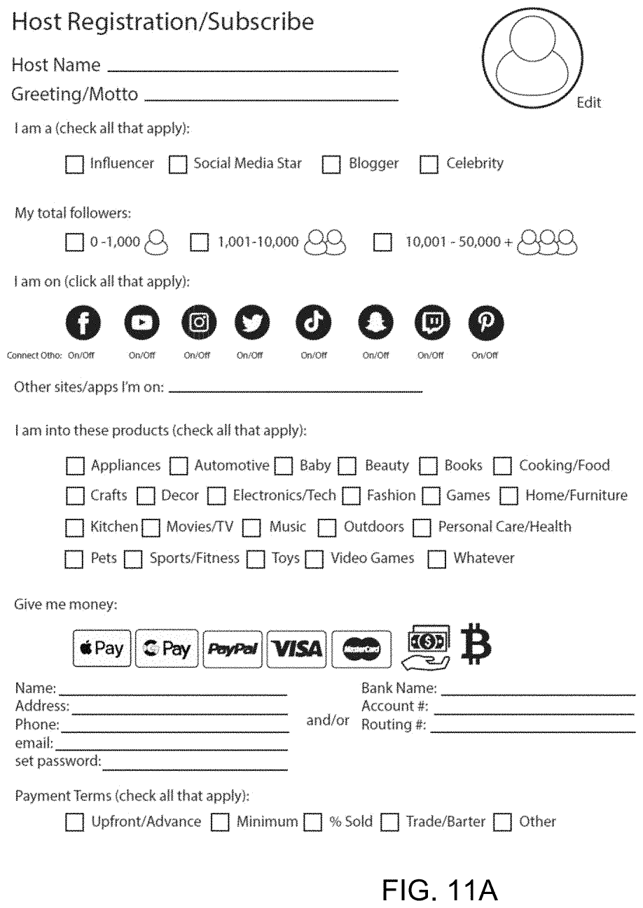

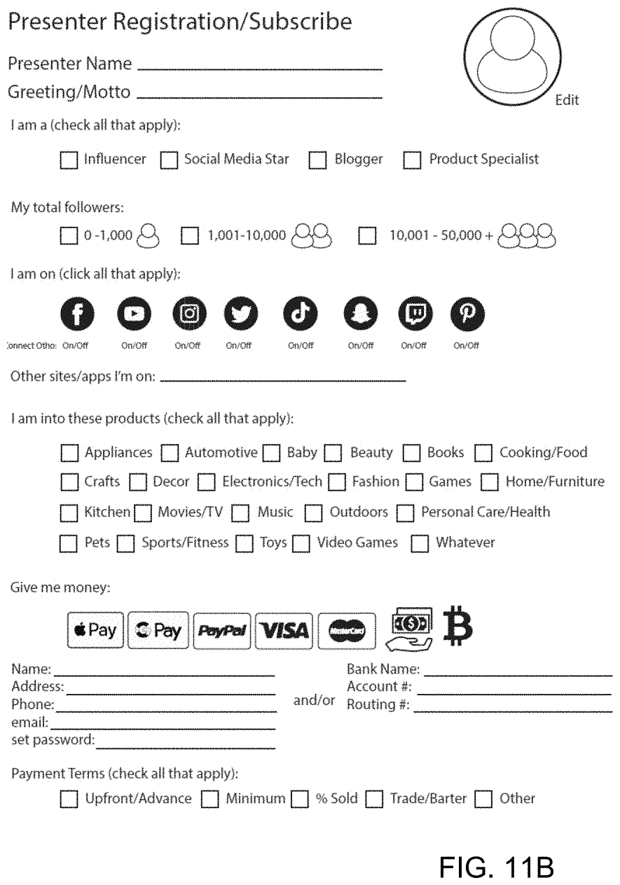

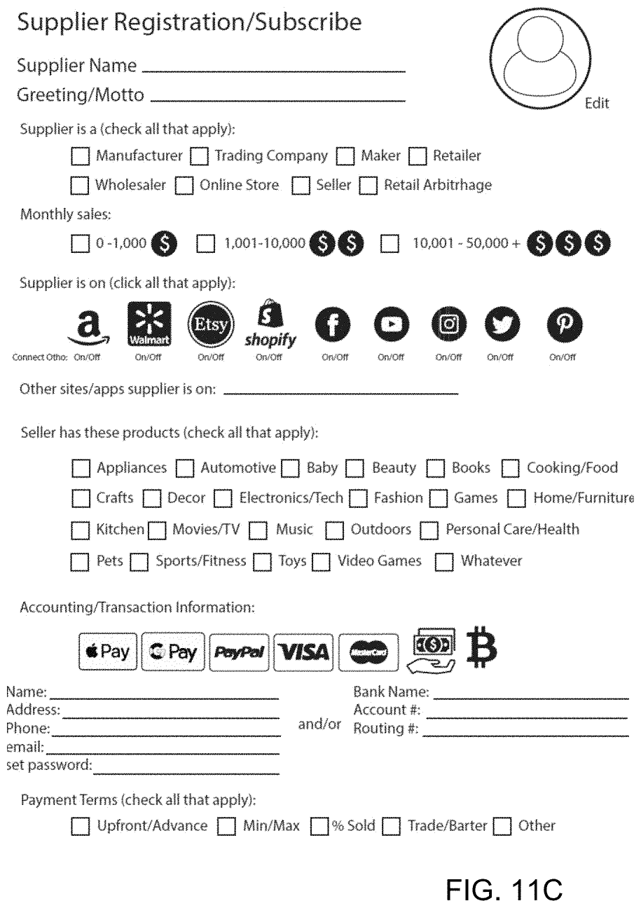

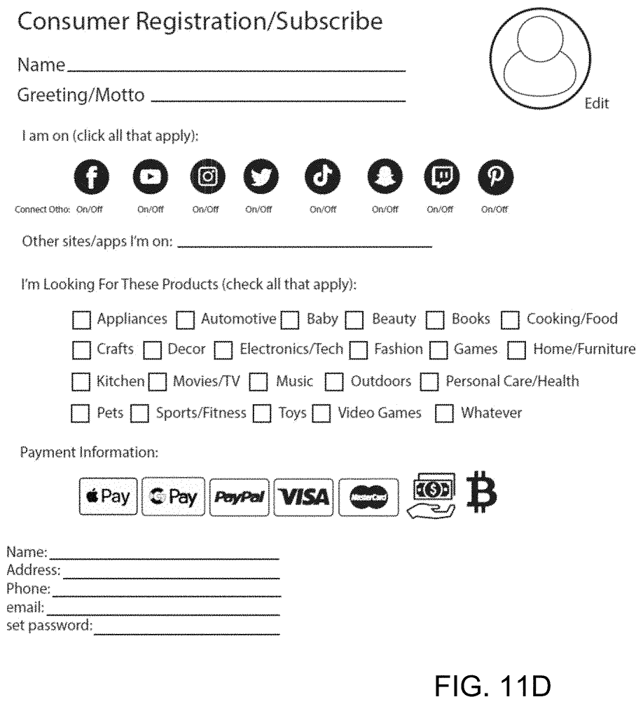

FIG. 1 depicts an exemplary system 100 for live-streaming advertisement. As shown, system 100 may include a platform administrator 102, network 104, a live streaming source 106, a live streaming server 108, live advertisement 112, user 114 and client devices 116. The network 104 represents communication pathways between the live streaming server 108, live advertisement 112 and client devices 114. It should be noted that while a single live streaming source 106 is depicted in the figure, it will be readily apparent that multiple cameras may, and are likely to, be employed at different locations, e.g., a separate streaming source 106 for each of the Host and Presenter. The platform administrator 102 is associated with one or more servers for communicating with the platform participants and users, including consumers. All system users will access the platform through the administrator 102, which provides network access and user interfaces such as shown in the sample screen shots in FIGS. 3, 4A, 4B, 6-9, and 10A-10F, the sign up access and forms as shown in FIGS. 10A-10C, and 11A-D.

The communication network 104 can comprise any combination of wired and/or wireless links; any combination of one or more types of networks by way of example including but not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), WiMax, Multihop relay networks, LiFi (Light Fidelity), Femtocells, Wireless USB and ultrawideband, Unified communications, LTE-A, Miracast, 802.11ac WLAN, WiGig, WirelessHD, HomePlug AV2, MHL (Mobile High-Definition Link), G.hn (Gigabit Home Networking), MOCA 2.0, Global System for Mobile Communications (GSM), Personal Communications Service (PCS), Digital Advanced Mobile Phone Service (D-Amps), Bluetooth, Wi-Fi, Fixed Wireless Data, UMTS W-CDMA, 2G, GPRS, HSPA+, 4G networks, 5G networks, messaging protocols such as, TCP/IP, SMS, MIMS, extensible messaging and presence protocol (XMPP), real time messaging protocol (RTMP), instant messaging and presence protocol (IMPP), instant messaging, USSD, IRC, WebRTC, or any other wireless data networks or messaging protocols. The network uses standard communications technologies and/or protocols and/or utilize any combination of transmission techniques and protocols. The data exchanged over the communication network 104 may be written in any combination of technologies and/or formats by way of example including but not limited to hypertext markup language (HTML), extensible markup language (XML), java script object notation (JSON) along with one or more programming languages which can be by way of example including but not limited to ASP, .NET, C, C#, C++, Java, Perl, PHP, Ruby, Python, etc. The communication network 104 can have all or some of links can be encrypted using conventional encryption technologies such as the secure sockets layer (SSL), Secure HTTP and/or virtual private networks (VPNs).

The platform administrator 102 communicates live advertisement by a web page and/or other application installed by users 112 on their client device 114. It should be noted that while the examples provided herein describe live video programming, the inventive system is not limited to video programming, but also may be applied to audio (e.g., talk radio), podcasts, or similar. The participants in video programming need not be live, on-screen personalities, but may be avatars, represented by a still photo of the person, or an animated version of the person.

Platform administrator 102 provides a match-making service that allows collaboration between hosts, presenters and suppliers to be displayed to users/consumers 114. Administrator 102 collects and maintains user information by way of sign up pages on an web page or app. The collection information may be maintained in a dedicated, secure platform database 103, or may be stored in secure cloud-based storage. It also provides a mechanism for conducting transactions including purchases of advertised products by consumers (users 114), collection of commissions from suppliers, distribution of commissions to hosts and presenters, and other financial functions. The financial functions of the administrator follow standard procedures that are widely used in commerce and may be performed via a separate transaction server 110, or preferably, by providing a redirect to the supplier's website for completion of the transaction, while retaining sufficient information about the transaction to allow tracking of sales generated via the platform to determine commissions due to the participants as well as the commissions or fees payable to entity acting as the platform administrator.

The live streaming servers 108 acquire video from the live-stream source 106. Live stream source 106A-N by way of example, including but not limited to, a communications satellite, a live broadcast camera, recording camera, desktop computer, a computer cluster, or portable devices including, a notebook, a laptop computer, a handheld computer, computer, a mobile phone, tablets, a cell phone, a PDA, a smart phone which can have and/or any combination of operating system including but not limited to like—Android®, OS, Apple® iOS, Windows®, Phone, WiFi phones, cover headsets, heads-up displays, smart watch, 3D glasses, virtual reality headsets, game consoles, car audio systems with camera, kiosks, helmet mounted display, a TV but not limited to LCD, Plasma, LED, 3D, Smart TV, Ultra HD, set top boxes, streaming devices, head-mounted display, scanned-beam display, wearable computer such as mobile enabled watches, etc.

The live streaming servers 108 may use any combination of hardware and/or software modules to implement live streaming protocols by way of example including but not limited to Adobe HDS, Apple HLS, Microsoft Smooth Streaming, MPEG-DASH streaming, Adobe RTMP, HTTP Live Streaming, RTSP (Real-time Streaming Protocol), RTP (Real-time Transport Protocol), RTP Control Protocol (RTCP), UDP (User Datagram Protocol), TCP (Transmission Control Protocol), IP Multicast, PIM (Protocol Independent Multicast), P2P (Peer-to-peer), HTML5 Streaming, Adaptive bitrate streaming (ABR), etc.

The live-streaming server 108 streams live advertisement 112 using network 104. The live streaming server 108 can be running an operating system by way of example including but not limiting to Linux, Mac OS X, Solaris, Unix, Ubuntu, FreeBSD, Windows Server, etc. or variants thereof. Although one server is shown for live-streaming server 108 in FIG. 1, there may be any number of servers added in the environment. The live advertisement 112ius provided to user 114 on client device 116A-N.

In one embodiment live advertisement 112 may contain a redirection link or mobile deep linking in live advertisement 112 to the administrator 102 website or landing page or third-party website or advertiser mobile app. When a user 114 clicks on the redirection link or mobile deep linking link they may be redirected to administrator 102 website or landing page or third party website or advertiser mobile app.

The client device 116A-N can be by way of example including but not limited to, a server desktop, a desktop computer, a computer cluster, or portable devices including, a notebook, a laptop computer, a tablet, a smart phone, or a smart watch which can have and/or any combination of operating system including but not limited to like—Android OS, iOS, Windows Phone, WiFi phones, open source cell phones, centralized storage cell phones, cloud storage cell phones, cover headsets, heads-up displays, 3D glasses, virtual reality headsets, game consoles, car audio systems, kiosks, in-vehicle or hand-held navigation systems, helmet mounted display, a TV but not limited to LCD, Plasma, LED, 3D, Smart TV, Ultra HD, set top boxes, streaming devices, head-mounted display, scanned-beam display, wearable computer such as mobile enabled watches, virtual and/or 3D glasses and/or any other mobile interfaces and viewing devices, etc. The client device 116A-N may be a location-aware device that is able to determine its own location or identify location information from an external source. In another embodiment client device 116A-N may contain software such as web browser or other application for viewing or listening to live programming.

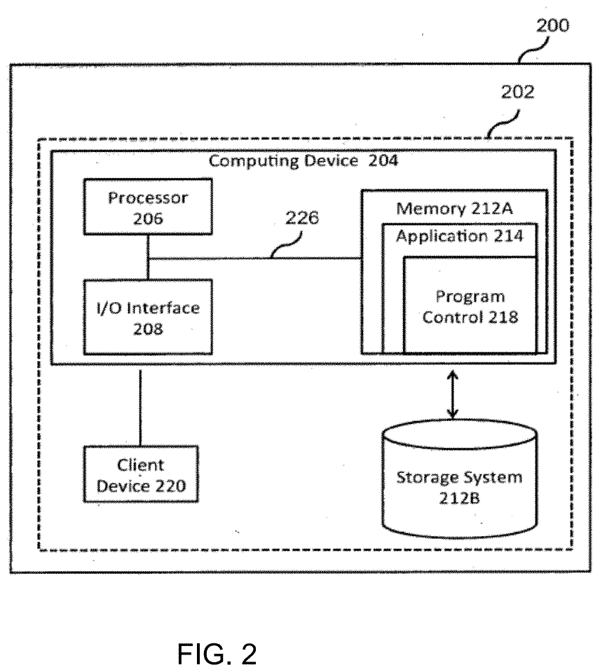

FIG. 2 shows an exemplary environment 200 for managing the processes in accordance with the invention. To this extent, the environment 200 includes a computer infrastructure 202 that can perform the processes described herein. In particular, the computer infrastructure 202 includes a computing device 204 that comprises an application 214 having a program control 218, which makes the computing device 204 operable to perform the processes described herein. For example, the computing device 204 includes a processor 206, a memory 212A, an input/output (I/O) interface 208, and a bus 226. The memory 212A can include local memory employed during actual execution of program code, bulk storage, and cache memories which provide temporary storage of at least some program code (e.g., program control 218) in order to reduce the number of times code must be retrieved from bulk storage during execution. Further, the computing device 204 is in communication with an external I/O device/resource 208 and a storage system 212B. The I/O device 220 can comprise any device that enables an individual to interact with the computing device 204 or any device that enables the computing device 204 to communicate with one or more other computing devices using any type of communications link.

The processor 206 executes computer program code (e.g., program control 218), which is stored in memory 212A and/or storage system 212B. While executing computer program code, the processor 206 can read and/or write data to/from memory 212A, storage system 212B, and/or I/O interface 208. The bus 226 provides a communications link between each of the components in the computing device 204.

The computing device 204 can comprise any general purpose computing device capable of executing computer program code installed thereon (e.g., a personal computer, server, tablet, smart phone, etc.). However, it is understood that the computing device 204 is only representative of various possible equivalent computing devices that may perform the processes described herein. To this extent the functionality provided by the computing device 204 can be implemented by a computing device that includes any combination of general and/or specific purpose hardware and/or computer program code. In each embodiment, the program code and hardware can be created using standard programming and engineering techniques, respectively. Similarly, the computer infrastructure 202 is only illustrative of various types of computer infrastructures for implementing the invention. For example, the computer infrastructure 202 may comprise two or more computing devices (e.g., a server cluster) that communicate over any type of communications link, such as a network, a shared memory, or the like, to perform the processes described herein. Further, while performing the processes described herein, one or more computing devices in the computer infrastructure 202 can communicate with one or more other computing devices external to computer infrastructure 202 using any type of communications link.

As will be appreciated by those of skill in the art, the present invention may be embodied as a system, a method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-readable media may be utilized. The computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, and/or a transmission media such as those supporting the Internet or an intranet, or a magnetic storage device.

The storage system 22B (e.g., database) may be managed by a database management system (DBMS), for example including but not limited to, Oracle, DB2, IMS DB, NoSQL, Microsoft SQL Server, PostgreSQL, MySQL, etc. The storage system 22B can be implemented by way of example including but not limited to object-oriented technology and/or via text files, and can be managed by a distributed database management system, an object-oriented database management system (OODBMS) (e.g., ConceptBase, FastDB Main Memory Database Management System, JDO Instruments, ObjectDB, etc.), an object-relational database management system (ORDBMS) (e.g., Informix, OpenLink Virtuoso, VMDS, etc.), a file system, and/or any other convenient or known database management package. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages which can be by way of example including but not limited to ASP, .NET, C, C#, C++, Java, Perl, PHP, Ruby, Python, etc. programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network can be used as described in 202.

Moving now to the operations of the programming, the inventive platform provides for a dating-app-style connection between individuals who wish to make money through one or more of hosting, presenting, or supplying products or services to potential customers via livestreaming presentations.

This social shopping platform can allow an influencer to log in and post their availability as a host to promote a product or service so they can make money. The host can connect with a presenter who is a product expert and via audio, text, or live chat find a supplier with available product or service.

The inventive platform also allows a supplier of a product or service to connect with a presenter and/or a host to present their product/service. Similarly, a presenter can seek out suppliers and hosts on this platform.

Basically, this platform provides an online venue for a presenter to go on and make money by demonstrating products or describing services, for a host to connect with their followers and monetize their personality, and for a product supplier to take advantage of the presenter's skills and host's popularity to expand their markets to sell their goods and/or services.

There can be a number of different ways in which the three entities can come together. Preferably, a standard agreement will be prepared, possibly with a few selectable variables such as percentage-based or fixed “commissions” to be offered to the different participants, with the options prearranged to simplify negotiations. This online platform allows social interaction and networking to eventually sell a product.

The basic functions/operations of the inventive platform will include:
1. Allow the social interaction for three entities, host/presenter/supplier, to take place.
2. During the presentation, the host will have the ability to guide the sale of the product, direct the presenter, post banners and prompts to the viewers. Host will have real time sales data allowing them the opportunity to maximize sales by directing the presenter and directing the live video.
3. The presenter can focus on being a product expert and be guided by the host to efficiently use the airing time thus maximize the sale of the product.
4. The viewer/consumer can engage with likes or comments, during the live broadcast, on the live chat box. The host can view the chat box and respond accordingly. Consumer purchases will be tallied and provided to the host as sales data.
5. The landing page will have a running video feed of the top selling or top viewed presentations in short 5-30 second loops. Allowing the viewer to stop on the one that catches their attention and immediately purchase. The homepage will allow consumers to choose a category and view videos in that category.
6. The host will have ability to choose the video thumbnail of the top-rated video in their category.

The inventive platform provides an outlet for hosts and presenters to monetize their popularity and skills, respectively, and for product/service suppliers to market their inventory. For sellers, they bring their products to the site to obtain assistance in finding the best presenter and host to maximize their sales. The hosts (influencers) bring their own audiences and know how to interact with their followers to move inventory.

For individuals who are skilled at presenting, for example, people who can demonstrate cooking, crafting, construction, painting, gardening, or any other activity that involves the use of a product for sale, they can take advantage of their expertise and earn a commission from the product sales. For hosts who have an established following and are able to connect with people, they can monetize their efforts and provide additional ways to interact with their followers.

Referring to the drawings, FIG. 3 illustrates a simulated home page for the inventive platform showing exemplary frames of a video of a presenter with an inset of the host who may provide supporting comments during the presentation, for example, “Isn't that amazing? Just think of how much your kids would love this toy.” The host may also review message from followers in real time to interject a question, such as “Hey, Tommy just asked whether that plane will perform loops”, prompting the presenter to modify or expand their demonstration to respond to the requester.

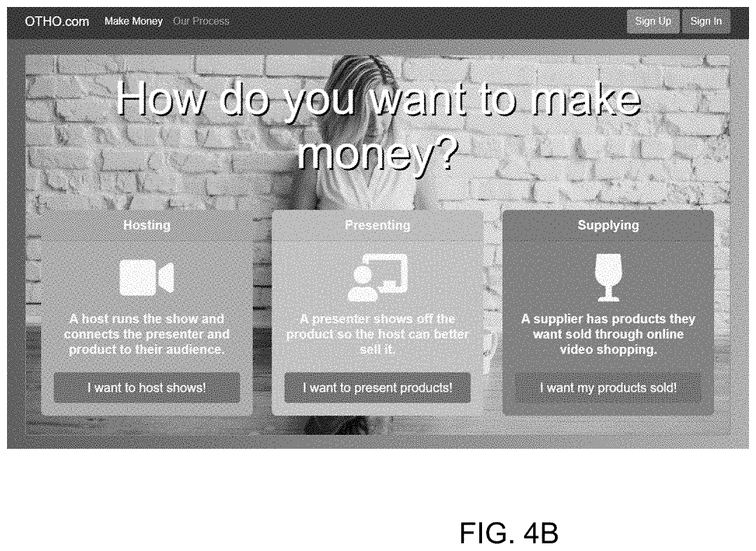

FIG. 4A is a diagrammatic screen shot of a webpage for selecting a user's area of interest in a marketing presentation, allowing the user to select how they want to participate. Once the user clicks on a selection, the app will take the user to another page with a host questionnaire. For example, for a host, the questions may include “how many followers do you have?”, “are there any special interests among your followers?”, “what demographics do you target?, etc. For presenters, clicking on the “I want to present button” will take the user to a questionnaire that will ask about particular skills and expertise. Suppliers will be taken to a page that requests details about the products/services, such as price range, inventory, availability, shipping details, etc. FIG. 4B is a screen shot of the corresponding webpage on a simulated website.

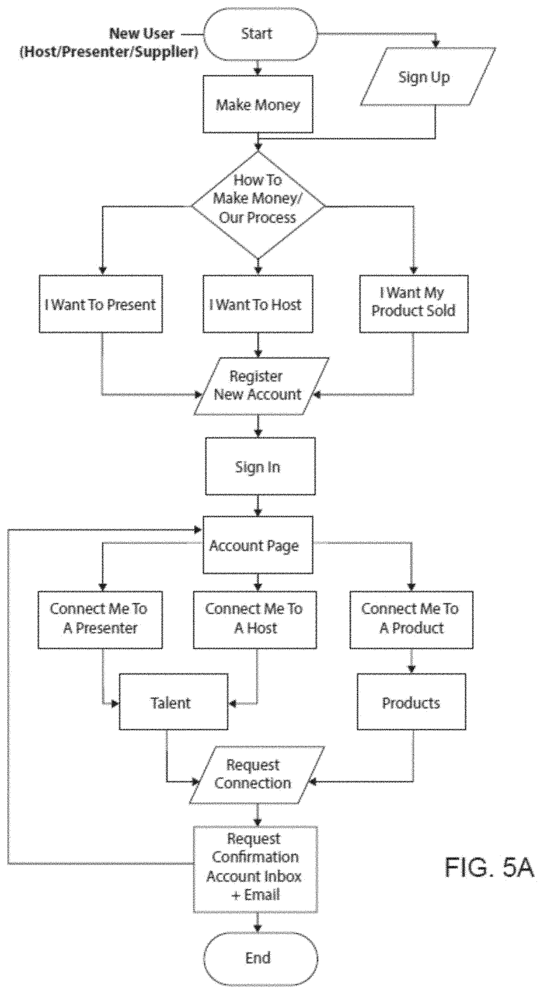

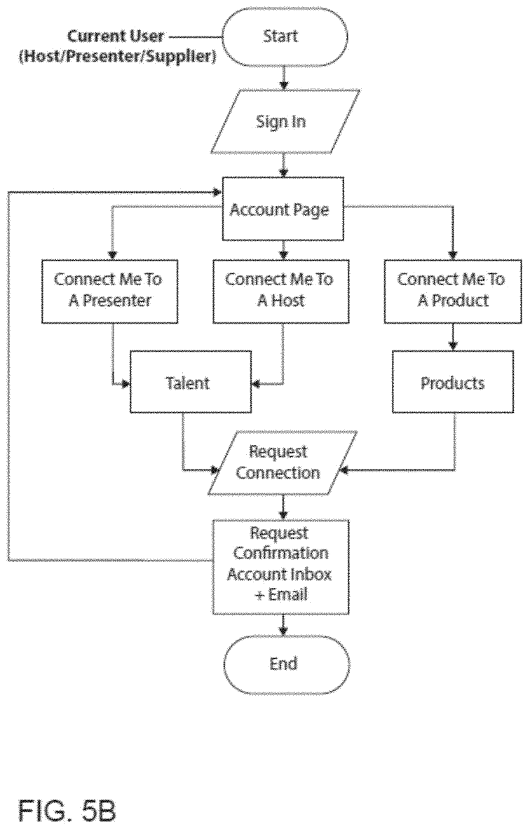

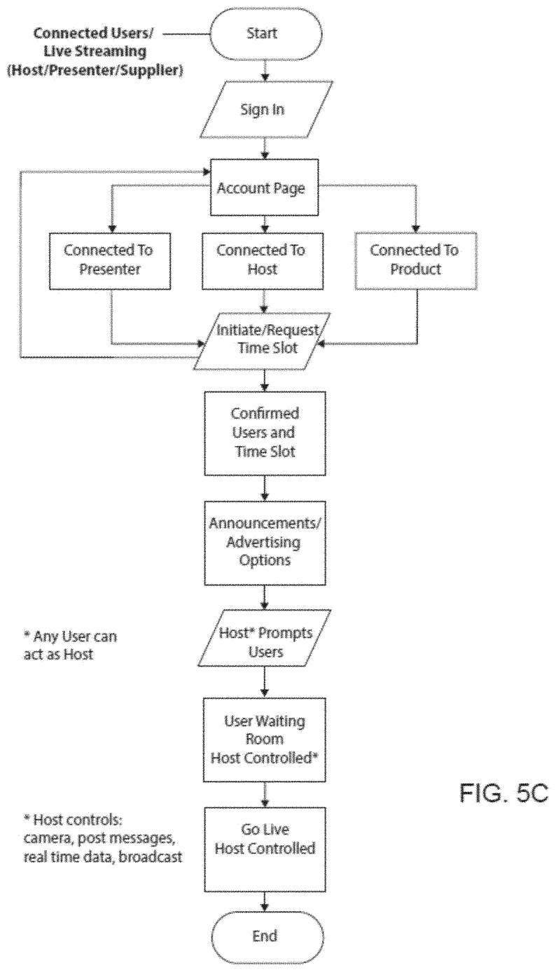

FIGS. 5A-5D are flowcharts illustrating the steps of different aspects of the inventive platform. FIG. 5A illustrates the steps for signing up a new user (host, presenter or supplier), setting up a new account, and selecting their desired type of participation. FIGS. 10A-10C provide examples of information at the host, presenter, and supplier would enter as part of the sign-up process, and FIGS. 11A-11C provide examples of more detailed questionnaires for creating accounts for a host, presenter, and supplier, respectively. FIG. 5B shows the steps by which an existing account holder can select their desired participation. FIG. 5C illustrates the steps for a user (host, presenter or supplier) to specify a particular live streaming activity to participate in and make arrangements for participation. FIG. 10D illustrates an example display of the account page of a platform user indicating activity status and preparation for a live streaming activity. This page may include ratings, e.g., stars, or “tier level” for that user. FIG. 5D provides the steps by which a viewer/consumer can select and view programming and/or purchase items offered on platform programming. FIG. 10E provides an example display of consumer account information and preferences. FIG. 11D provides an example questionnaire for consumer registration/subscription.

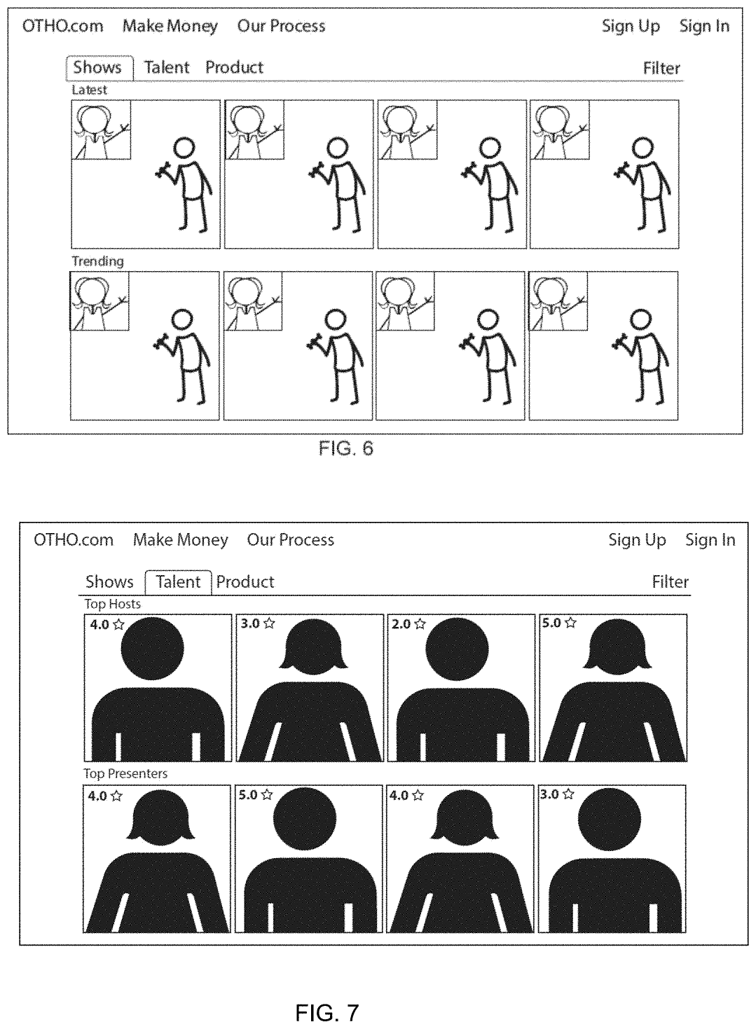

FIG. 6 displays images of different programming options available for selection by prospective consumers who visit the website to view the hosted presentations. In this example, programming selections are categorized as the newest programming (upper panel) and trending programming (lower channel). Other groupings may be applied, or no groupings may be used.

FIG. 7 displays images of talent options from which a supplier may select individuals who would be suitable for hosting and/or presenting the supplier's products or services. For a supplier seeking a host and/or presenter, they may simply start off by selecting someone who has the look that they believe will reach their intended audience, or additional information may be provided in the different talent windows. For example, under presenters, a brief caption might include “Four Star Chef” for a cooking related product, or “Dog Trainer to the Stars”. For hosts, the caption might include, for example, “Skateboarding Influencer”, 120,000 followers.” The images or thumbprints for each person may include a rating based on past successes, popularity, or polling/review data, e.g., “3 stars”, “4 stars”, etc. The supplier would then select the person(s) that they believe would be best suited to promote their product/services to the desired audience.

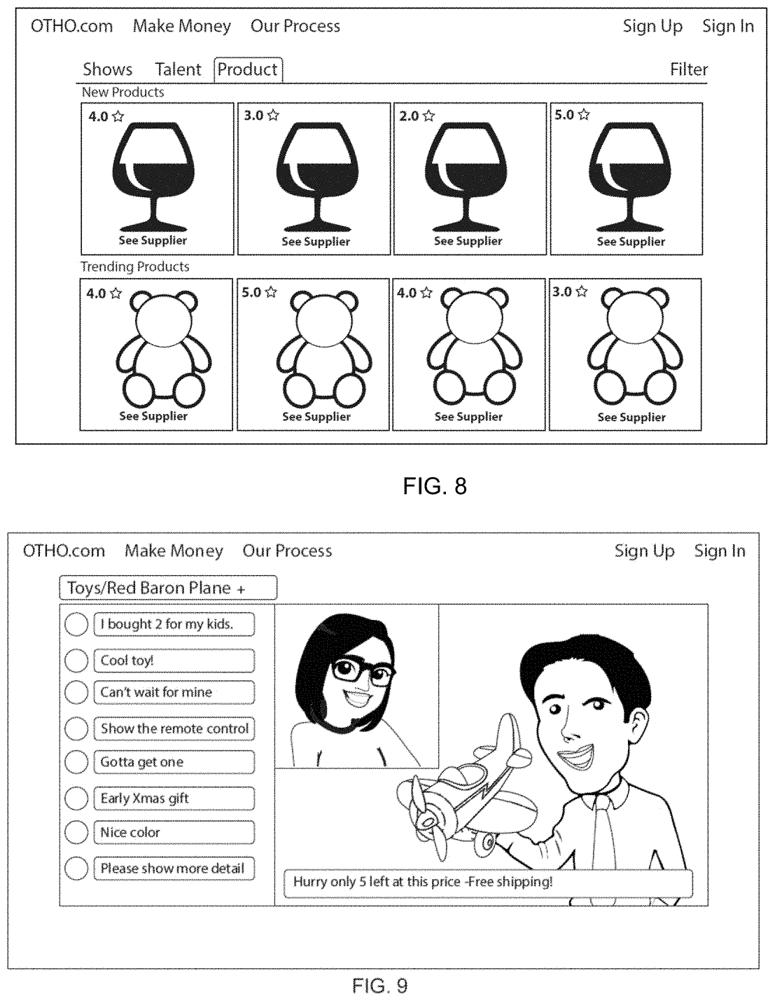

FIG. 8 displays sample images of different product options from which a prospective customer can select. In this example, product options are categorized according to newest offerings (upper panel) and trending products (lower panel). The images or thumbprints for products may also include a rating based o polling/review data, e.g., “3 stars”, “4 stars”, etc., or based on how recently the product has been added, e.g., “4 star fresh.” Clicking on any of these options will take the site visitor to a presentation about that product. As will be readily apparent to those in the art, other grouping may be applied, or a search capability may be provided to allow the visitor to search for a particular product category, e.g., toys, clothing, tools, etc.

FIG. 9 displays a sample image with a chat/comment box allowing viewers to comment on the product or programming and interact with or provide feedback for the presenter and/or host. Preferably, this page will allow the host to convey information from their viewing audience to the presenter to provide customized information, or it can allow for promotional comments or product reviews (positive) to boost sales. In the illustrated example, the graphic can include a statement about remaining inventory to encourage viewers to act quickly.

Optionally included within the overall programming service can be one or more behind the scenes profile page(s) that will be accessible to the various users depending on the type of participation. Referring to FIG. 10F, a user may click on a specific host, presenter or supplier to be taken to a profile pages for that entity. The profile page may include data such as current or high rated video sales, star rating, tier level, posts, payment terms, related hosts/presenters/suppliers, etc. For example, the user may click on “See Sales” for data on sale volume, total dollars (tier level), sales history, (numerical, graphical, or a combination), and other data. Reviews may include moderated comments. Examples of possible comments might include information such as “does not pay timely”, or “amazing sales with this Host”. The profile page can be set up as public, private, or limited access. For example, profiles of hosts might be accessible only to suppliers, or to suppliers and presenters, or to only users with a “premium” subscription. As will be apparent to those in the art, any number of permutations may be set up according to the needs of the users.

The manner in which the participants in the inventive scheme are paid can be configured in any of the number of ways, including fixed fee, a flexible commission structure, or combinations thereof. The terms of the compensation arrangements can be negotiated at the outset of the partnering, and may include bonuses and incentives based on milestones and other triggers. In general, the inventive program can generate revenue both through commissions and advertising. In the most basic approach, a simple commission arrangement would involve compensation based on a fixed percentage, e.g., 1-10%, on all sales generated from the supplier whose products are being sold, or advertising revenue from ads that may appear during a session. The following provides a few sample scenarios for illustration purposes. These examples are not intended to be limiting, and expansions and/or additional variations will be apparent to those of skill in the art.

Scenario 1:
Supplier can set the price of a product and offer commission e.g., 30% total, then solicits Presenter/Host.
Host wants 20%, which leaves 10% for the Presenter. The Presenter can respond by:
   A. Countering for 15%;
   B. Declining to participate;
   C. Accepting the match and the airing scheduled

Scenario 2:
Top earning Host sends a message to a supplier offering to sell their product, requesting a 30% commission.
Supplier is hesitant but needs exposure, so they agree and adjust total commission to 40% to include a Host (10%).

Scenario 3:
Presenter is looking for exposure, so they are willing to work for 5%.
They solicit a top Host who can get them more views. The Host agrees and they find a Supplier for the appropriate product.

A unique feature of the inventive match-making process not only brings Presenters, Hosts, and Suppliers together, but maximizes the selling potential thru this process with multiple selling methods created by the three entities in unlimited combinations. This is further enhanced by the abilities for the three entities to engage in combinations of commissions accepted by the three entities allowing each entity to maximize their respective goals. The following provides another illustrative example:
A given product sells for $100.00
Distributor offers total of 40% commission; i.e., $40.00.
The platform administrator charges a standard commission of 5%.
A host could accept the offer to sell with a request of 30% of the sale leaving 10% for the presenter. Of the multiple presenters reviewing the request to air the item sees that this host wants to sell on a specific date a product from this distributor and the only commission remaining is 10%, or $10 for each product sold. The presenter, by reviewing the profile for this particular host, can review their sales history, reviews, and rating, and may decide that it is worth taking only 10% since the chances of success with this particular host are high. The presenter then agrees to the offer. The sale takes place and the proceeds are divided out, for example 5% to the platform administrator, 30% to host, and 10% to presenter, leaving 55% to distributor. The permutations of this are virtually unlimited between the three entities which provides for the best chance of success to join in a business relationship and ultimately create the best-selling potential of the product.

The foregoing description provides illustrative examples of implementation of a platform for on-line advertising of products and services to interested consumers. Various elements of each sample activity, display, or function can be used in different combinations with other elements and, therefore, are not intended to be limited to the specific example in which they are illustrated.

1. A platform for streaming live advertising to prospective consumers, the platform comprising:
a platform administrator comprising one or more administration servers in communication with a network for providing user access to streaming content and for coordinating collaboration between entities, wherein the entities comprise a host, a presenter, and a supplier, wherein the host is one or more first entity who directs a sales presentation, the presenter is one or more second entity who provides the sales presentation of a product under direction by the host;
wherein the one or more administration servers are configured to accept subscriptions from the entities and provide communication links between the entities to allow one entity to select from, negotiate, and establish a collaboration with other entities for generating streaming content advertising a supplier's product; and
wherein the platform administrator is further configured to receive requests for scheduling a time slot for a streaming event associate with an established collaboration between entities and to distribute the streaming content to consumer devices for display to the prospective consumers.

2. The platform of claim 1, wherein the platform administration is further configured to facilitate transactions initiated by consumers for purchase of the supplier's product.

3. The platform of claim 1, wherein the platform administration is further configured to determine compensation to one or more of the entities based on sales of the supplier's product and a negotiated compensation arrangement between collaborating entities.

4. The platform of claim 1, wherein the host and the presenter generate streaming content at a common location.

5. The platform of claim 1, wherein the host and the presenter generate streaming content at remote locations.

6. The platform of claim 1, wherein the host comprises a celebrity or influencer.

7. The platform of claim 1, wherein the platform administration is further configured to receive inquiries or comments from the prospective consumers during live streaming of the streaming content and to provide the inquiries or comments to the host for directing the sales presentation.

8. The platform of claim 1, wherein the platform administration is further configured to collect reviews or ratings of one or more entity from other entities and to generate entity profiles to facilitate selection of an entity for a specific sales presentation.

9. The platform of claim 1, wherein the streaming content is live video.

10. The platform of claim 1, wherein the streaming content is audio only.

11. The platform of claim 1, wherein one or more of the entities appears in the streaming content as an avatar.

12. A method for streaming live advertising to prospective consumers, the method comprising:
providing a platform within a network for providing user access to streaming content and for coordinating collaboration between entities, wherein the entities comprise a host, a presenter, and a supplier, wherein the host is one or more first entity who directs a sales presentation, the presenter is one or more second entity who provides the sales presentation of a product under direction by the host;
providing communication links between the entities to allow one entity to select from, negotiate, and establish a collaboration with other entities for generating streaming content advertising a supplier's product; and
receiving requests for scheduling a time slot for a streaming event associate with an established collaboration between entities and to distribute the streaming content to consumer devices for display to the prospective consumers.

13. The method of claim 12, further comprising facilitating transactions initiated by consumers for purchase of the supplier's product.

14. The method of claim 12, determining compensation to one or more of the entities based on sales of the supplier's product and a negotiated compensation arrangement between collaborating entities.

15. The method of claim 12, wherein the host and the presenter generate streaming content at a common location.

16. The method of claim 12, wherein the host and the presenter generate streaming content at remote locations.

17. The method of claim 12, further comprising receiving inquiries or comments from the prospective consumers during live streaming of the streaming content and providing the inquiries or comments to the host for directing the sales presentation.

18. The method of claim 12, further comprising collecting reviews or ratings of one or more entity from other entities and to generate entity profiles to facilitate selection of an entity for a specific sales presentation.

19. The method of claim 12, wherein the streaming content is one of live video and live audio.

20. The method of claim 12, wherein one or more of the entities appears in the streaming content as an avatar.
